(19) United States
(12) Patent Application Publication
(10) Pub. No.: US 2011/0152460 A1
(43) Pub. Date: Jun. 23, 2011

(54) SYNDIOTACTIC PROPYLENE BASED POLYMER COMPOSITION, FORMED BODY, AND LAMINATED SHEET

(75) Inventors: Naomi URAKAWA, Sodegaura-shi (JP); Yoshisada Tamo, Ichihara-shi (JP); Makoto Nakano, Chiba-shi (JP); Takashi Nakagawa, Arao-shi (JP); Ryosuke Aburaki, Ichihara-shi (JP); Akihiro Matsuda, Yokohama-shi (JP)

(73) Assignee: Mitsui Chemicals, Inc.

(21) Appl. No.: 12/973,527

(22) Filed: Dec. 20, 2010

Related U.S. Application Data
(60) Provisional application No. 61/378,267, filed on Aug. 30, 2010.

(30) Foreign Application Priority Data
Dec. 21, 2009 (JP) 2009-289411

(51) Int. Cl. C08L 31/04; C08L 23/06; C08L 23/12; B32B 37/06

(52) U.S. Cl. 525/222; 525/240; 156/60

(57) ABSTRACT

[Object] The object of the present invention is to develop a syndiotactic propylene based polymer composition, which has excellent calendering formability, which exhibits excellent abrasion resistance, scratch resistance, and the like and, in addition, which is suitable for a sheet for an artificial leather exhibiting improved smell, color migration, and the like.

[Solution] The present invention relates to a syndiotactic propylene based polymer composition containing a syndiotactic propylene-a-olefin copolymer containing 50 percent by mole or more, and less than 90 percent by mole of repeating unit derived from propylene, a syndiotactic propylene polymer containing 90 to 100 percent by mole of repeating unit derived from propylene, ethylene-vinyl acetate copolymer, ethylene (co)polymer, and isotactic polypropylene, as well as a formed body and a laminated sheet.

### TECHNICAL FIELD

The present invention relates to a syndiotactic propylene based polymer composition, which has excellent calendering formability, which exhibits excellent abrasion resistance, scratch resistance, and the like and, in addition, which is suitable for obtaining a laminated sheet for an artificial leather exhibiting improved smell, color migration, and the like, and a formed body and a laminated sheet.

### BACKGROUND ART

A polyvinyl chloride (PVC), in particular a soft PVC, is one of materials most frequently used as a sheet or a film for an artificial leather (hereafter a sheet or a film may be generically referred to as a “sheet”) because there are features that, for example, the hardness can be changed freely by adjusting the amount of a plasticizer, coloring is performed easily, and a surface appearance can be changed by extrusion, calendering, or the like and excellent chemical resistance, weatherability, heat resistance, secondary formability, and the like are exhibited. Furthermore, a polyurethane elastomer has an excellent modulus of elasticity in a wide hardness range, exhibits excellent load resistance, mechanical strength, oil resistance, abrasion resistance, and the like and, therefore, is one of materials suitable for a sheet for an artificial leather.

The calendering is a forming method to form a resin into the shape of a sheet by using rolls and has a feature that the productivity is high as compared with that of extrusion sheet forming. As for the calendering, usually, a four-roll calendering is used frequently. Most of resins used for the calendering is PVC, and it has been believed that olefin based resins are unsuitable for the calendering. Since there are various problems, a switch from the PVC resin to the olefin based resin has been required. However, the olefin based resin exhibits poor calendering formability and, therefore, a switch to the olefin based resin has not proceeded.

Regarding the calendering, main problems are for example a bank mark, an irregular thickness, a pinhole, failure peeling from rolls, and insufficient adhension to rolls. The bank mark refers to a phenomenon in which a very thin V-shaped wavelike pattern remains on a sheet surface. The irregular thickness refers to that the thickness of the sheet becomes uneven. The pinhole refers to that air entrained in a resin is not deaerated in the bank and a bubble enters a sheet so as to make a hole. The failure peeling from rolls refers to that a resin is not peeled off a roll so as to wind itself around the roll. The insufficient adhension to the rolls refers to that a resin is not adhered between rolls, a bank becomes larger steadily, and the resin overflows. Among them, the failure peeling from rolls and the insufficient adhension to rolls are phenomena not observed with respect to the calendering of PVC, but observed with respect to the calendaring of olefin based resins and, therefore, are problems in the forming.

However, the soft PVC contains a large amount of plasticizer and, thereby, color migration and smell occur. Furthermore, a long term of use tends to cause hardening due to migration of the plasticizer. Moreover, the individual materials have their respective drawbacks. For example, polyurethane elastomer exhibits poor moisture resistance and secondary formability.

As for materials serving as alternatives to the soft PVC and the urethane elastomer, a soft syndiotactic polypropylene based composition containing a syndiotactic propylene polymer as a primary component and a syndiotactic structure propylene·ethylene copolymer, an amorphous α-olefin based copolymer, an ethylene-α-olefin based copolymer, and an isotactic propylene polymer (PTL 1: Japanese Unexamined Patent Application Publication No. 2001-172448) has been proposed.

As for a method for improving the calendering formability of the syndiotactic propylene polymer composition, a method, in which syndiotactic polypropylene is mixed with ethylene based copolymers, e.g., an ethylene·vinyl acetate copolymer, an ethylene·methyl methacrylate copolymer, an ethylene·methyl acrylate copolymer, and an ethylene·ethyl acrylate copolymer, (PTL 2: Japanese Unexamined Patent Application Publication No. H08-48831), has been proposed.

However, the above-described composition containing the syndiotactic propylene polymer as a primary component does not yet have satisfactory calendering formability, heat resistance, strength, abrasion resistance, and the like.

### [Citation List]

[Patent Literature]

[PTL 1] Japanese Unexamined Patent Application Publication No. 2001-172448

[PTL 2] Japanese Unexamined Patent Application Publication No. H08-48831

### SUMMARY OF INVENTION

[Technical Problem]

It is an object of the present invention to develop a syndiotactic propylene based polymer composition, a formed body, and a laminated sheet, which have excellent calendering formability, which exhibit excellent abrasion resistance, scratch resistance, and the like and, in addition, which are suitable for a sheet for an artificial leather exhibiting improved smell, color migration, and the like.

[Solution to Problem]

The present invention provides a syndiotactic propylene based polymer composition comprising, (A) 35 to 95 parts by weight of syndiotactic propylene·α-olefin copolymer containing 50 percent by mole or more, and less than 90 percent by mole of repeating unit derived from propylene, (B) 5 to 25 parts by weight of syndiotactic propylene polymer characterized by satisfying the following requirement (b), the requirement being such that (b) the syndiotactic pentad fraction (rrrr fraction) measured on the basis of ¹³C·NMR is 85% or more, the melting point (Tm) determined on the basis of DSC is 145° C. or higher, and the repeating unit derived from propylene at an amount of more than 90 percent by mole (where the total amount of repeating unit in the syndiotactic propylene polymer (B) is assumed to be 100 percent by mole) and (C) 0 to 60 parts by weight of polymer or resin composition containing at least one type of the following (C-1) and (C-2), (C-1) an ethylene vinyl acetate copolymer, (C-2) a polyolefin based resin composition composed of the following (C-2-1) and (C-2-2) [where (C-2-1)+(C-2-2)=100 percent by weight], (C-2-1) 30 to 100 percent by weight of ethylene (co)polymer, (C-2-2) 0 to 70 percent by weight of isotactic polypropylene, [where (A)+(B)+(C)=100 parts by weight].

The present invention also provides a formed body, e.g., a sheet and a laminated sheet, obtained from the polymer composition and a method for manufacturing a sheet.

### [Advantageous Effects of Invention]

The syndiotactic propylene based polymer composition according to the present invention has features that, for example, the melting behaviour (easiness in melting of resin) in the calendering and take-off property from the rolls are excellent, sagging of the sheet does not occur in carrying, the calendering formability is excellent, and the resulting formed body, e.g., the sheet, exhibits excellent abrasion resistance, scratch resistance, and the like and, in addition, smell and color migration are not recognized.

### DESCRIPTION OF EMBODIMENTS

<Syndiotactic propylene·α-olefin copolymer (A)>

The syndiotactic propylene·α-olefin copolymer (A), which is a primary component of the syndiotactic propylene based polymer composition according to the present invention, is a copolymer containing the repeating unit derived from propylene at an amount of 50 percent by mole or more, and less than 90 percent by mole, preferably 55 percent by mole or more, and less than 90 percent by mole, and more preferably 60 percent by mole or more, and less than 90 percent by mole (the total of the repeating unit derived from propylene and the unit derived from α-olefin is assumed to be 100 percent by mole).

The α-olefin constituting the syndiotactic propylene·α-olefin copolymer (A) according to the present invention is usually an α-olefin having the carbon number of 2 to 20 (where propylene is excluded), e.g., ethylene, 1-butene, 1-pentene, 1-hexene, 1-octene, 4-methyl-l-pentene, 3-methyl-1-pentene, 1-decene, 1-dodecene, 1-tetradecene, 1-hexadecene, 1-octadecene, and 1-eicosene. One type or at least two types of these α-olefins may be contained.

Preferable examples of syndiotactic propylene·α-olefin copolymers (A) according to the present invention can include syndiotactic propylene·α-olefin having the carbon number of 2 to 20 copolymers (A1), specifically syndiotactic propylene·ethylene copolymers and syndiotactic propylene·1-butene copolymers, and syndiotactic propylene·ethylene·α-olefin having the carbon number of 4 to 20 copolymers (A2), specifically syndiotactic propylene·ethylene·1-butene copolymers.

The syndiotactic propylene·α-olefin copolymer (A) according to the present invention [in this regard, in the case where the wording, syndiotactic propylene·α-olefin copolymers (A), is employed, the above-described syndiotactic propylene·α-olefin having the carbon number of 2 to 20 (where propylene is excluded) copolymers (A1) and the syndiotactic propylene-ethylene·α-olefin having the carbon number of 4 to 20 copolymers (A2) are included] contains the repeating unit derived from propylene in the above-described range and, thereby, the compatibility with the syndiotactic propylene polymer (B) is excellent, and the resulting syndiotactic propylene based polymer composition exhibits excellent transparency, flexibility, heat resistance, scratch resistance, and abrasion resistance.

It is desirable that the limiting viscosity [η] measured in decalin at 135° C. of the syndiotactic propylene·α-olefin copolymer (A) according to the present invention is usually within the range of 0.01 to 10 dl/g, preferably 0.05 to 10 dl/g. In the case where the limiting viscosity [η] is within the above-described range, a syndiotactic propylene based polymer composition having excellent characteristics, such as, the weatherability, the ozone resistance, the heat aging resistance, the low-temperature characteristic, and the dynamic fatigue resistance is obtained.

Furthermore, the syndiotactic propylene·α-olefin copolymer (A) according to the present invention has a melting point measured with DSC (differential scanning calorimeter) of preferably 90° C. or lower or no melting point observed and, therefore, is a low-crystallinity or amorphous copolymer. In this regard, the above-described melting point measured with DSC refers to a temperature at a maximum melting peak position during temperature raising, the temperature being determined from a DSC endothermic curve, in particular, a temperature at the maximum melting peak position determined from the endothermic curve obtained in the item (iii), where a sample is packed into an aluminum pan, (i) temperature is raised to 200° C. at 100° C./rain and is kept at 200° C. for 5 minutes, (ii) the temperature is lowered to −150° C. at 10° C./min, and (iii) the temperature is raised at 10° C./min. Moreover, the term “have no melting point observed” refers to that a melting peak of a crystal having an amount of heat of melting of 1 J/g or more is not observed within the range of −150° C. to 200° C.

In addition, it is preferable that Tg measured with DSC of the syndiotactic propylene·α-olefin copolymer (A) according to the present invention is −10° C. or lower. In the case where the glass transition temperature Tg of the syndiotactic propylene·α-olefin copolymer (A) is within the above-described range, a syndiotactic propylene based polymer composition exhibiting excellent vibration controllability (vibration characteristics, vibration isolation performance, acoustic insulation performance, and sound absorbency), cold resistance, and low-temperature characteristic is obtained.

The syndiotactic propylene·α-olefin copolymer (A) according to the present invention is obtained by manufacturing methods described in Japanese Unexamined Patent

Application Publication No. 2001-172448, International Patent Publication WO 2006/123759, and the like.

<Syndiotactic Propylene Polymer (B)>

The syndiotactic propylene polymer (B), which is one of polymer components contained in the syndiotactic propylene based polymer composition according to the present invention, is a propylene homopolymer or a propylene based random copolymer obtained from propylene and an α-olefin having the carbon atom number of 2 to 20 excluding propylene and characterized by satisfying the following requirement (b). (b): The syndiotactic pentad fraction (rrrr fraction) measured on the basis of ¹³C·NMR is 85% or more, the melting point (Tm) determined on the basis of DSC is 145° C. or higher, and the repeating unit derived from propylene is contained at a proportion of 90 percent by mole to 100 percent by mole, preferably 92 to 100 percent by mole, and further preferably 95 to 100 percent by mole (where the total amount of repeating unit in the syndiotactic propylene polymer (B) is assumed to be 100 percent by mole).

Here, examples of α-olefins having the carbon atom number of 2 to 20 (where propylene is excluded) include ethylene, 1-butene, 1-pentene, 1-hexene, 1-octene, 4-methyl-1-pentene, 3-methyl-l-pentene, 1-decene, 1-dodecene, 1-tetradecene, 1-hexadecene, 1-octadecene, and 1-eicosene. Among them, 1-butene is preferable.

The above-described syndiotactic propylene polymer (B) has a syndiotactic pentad fraction (rrrr fraction, pentad syndiotacticity) measured by the NMR method is 85% or more, preferably 90% or more, more preferably 93% or more, and further preferably 94% or more. The syndiotactic propylene polymer (B) having an rrrr fraction within the above-described range exhibits excellent formability, heat resistance, and transparency, and good characteristics as a crystalline polypropylene are exhibited. Furthermore, in the case where the syndiotactic propylene polymer (B) is used, crystallization is suppressed and reduction in crystallinity and fine spherocrystallization occur and, thereby, the resulting syndiotactic propylene based polymer composition according to the present invention exhibits high transparency and surface glossiness.

This syndiotactic pentad fraction (rrrr fraction) is measured as described below.

The rrrr fraction is determined by the following formula (1) from the absorption intensity Prrrr (absorption intensity attributed to a methyl group in the third unit at the site where five propylene units constitute continuous syndiotactic bond) and the absorption intensity Pw (absorption intensity attributed to all methyl groups in the propylene units) in a ¹³C·NMR spectrum.

rrrr fraction (%)=100×Prrrr/Pw (1)

The NMR measurement is performed as described below, for example. That is, 0.35 g of sample is heat-dissolved into 2.0 ml of hexachlorobutadiene. After the resulting solution is filtrated with a glass filter (G2), 0.5 ml of deuterated benzene is added, and putting into an NMR tube having an inside diameter of 10 mm is performed. Subsequently, the ¹³C·NMR measurement is performed at 120° C. by using Model GX-500 NMR measuring apparatus produced by JEOL LTD. The number of integration is specified to be 8,000 times or more.

Moreover, the melting point (Tm) measured with a differential scanning calorimeter (DSC) of the syndiotactic propylene polymer (B) is 145° C. or higher, preferably 147° C. or higher, more preferably 150° C. or higher, and particularly preferably 155° C. or higher. The upper limit of Tm is not particularly specified, but is usually, for example, 170° C. or lower. The syndiotactic propylene polymer (B) having a melting point (Tm) within the above-described range exhibits excellent formability, heat resistance, and mechanical characteristics.

It is desirable that the limiting viscosity [1] measured in decalin at 135° C. of the syndiotactic propylene polymer (B) according to the present invention is within the range of preferably 0.5 to 10 dl/g, more preferably 1.0 to 6 dl/g, and further preferably 1.0 to 4 dl/g. In the case where the limiting viscosity is within the above-described range, good fluidity is exhibited, blending with other components is performed easily, and a formed body having excellent mechanical strength tends to be obtained from the resulting syndiotactic propylene based polymer composition.

The syndiotactic propylene polymer (B) according to the present invention is obtained by manufacturing methods described in International Patent Publication WO 2006/123759 and the like.

<Ethylene·vinyl acetate copolymer (C-1)>

The ethylene vinyl acetate copolymer (C-1), which is one of polymer components contained in the syndiotactic propylene based polymer composition according to the present invention, is usually a copolymer containing 1 to 49 percent by weight, and preferably 5 to 49 percent by weight of unit derived from vinyl acetate in consideration of the compatibility with the syndiotactic propylene·α-olefin copolymer (A) and the syndiotactic propylene polymer (B). If the unit derived from vinyl acetate is less than the above-described range, an effect of mixing of the ethylene·vinyl acetate copolymer is reduced significantly. Reversely, if the unit exceeds the above-described range, adhesion to roll occurs easily in forming of a sheet.

The MFR (JIS K7210.1999, 190° C., 2.16 kg load) of the ethylene·vinyl acetate copolymer (C-1) according to the present invention is usually within the range of 0.05 to 100 g/10 min, and preferably 0.1 to 50 g/10 min. In the case where the MFR is within the above-described range, good fluidity is exhibited, blending with other components is performed easily, and the resulting syndiotactic propylene based polymer composition exhibits excellent take-off property from the rolls in forming of a sheet.

<Polyolefin based resin composition (C-2)>

The polyolefin based resin composition (C-2), which is one of polymer components contained in the syndiotactic propylene based polymer composition according to the present invention, is a polyolefin based resin composition composed of the following (C-2-1) and (C-2-2). (C-2-1) 30 to 100 percent by weight of ethylene (co)polymer, (C-2-2) 0 to 70 percent by weight of isotactic polypropylene [where (C-2-1)+(C-2-2)=100 percent by weight]

<Ethylene (co)polymer (C-2-1)>

The ethylene (co)polymer (C-2-1), which is one of polymer components contained in the syndiotactic propylene based polymer composition according to the present invention, is usually an ethylene homopolymer or a copolymer of ethylene and an α-olefin having the carbon number of 3 to 20, e.g., propylene, 1-butene, 1-pentene, 1-hexene, 1-octene, 4-methyl-1-pentene, 3-methyl-1-pentene, 1-decene, 1-dodecene, 1-tetradecene, 1-hexadecene, 1-octadecene, and 1-eicosene, containing ethylene as a primary component, which has a density within the range of 860 to 950 kg/m³, and preferably 860 to 920 kg/cm³. In the case where the density is within the above-described range, a flexible sheet/film can be obtained. In the case where the ethylene (co)polymer (C-2-1) according to the present invention is a copolymer, usually, the content of the unit derived from the α-olefin is within the range of 5 to 49 percent by mole.

The MFR (JIS K7210.1999, 190° C., 2.16 kg load) of the ethylene (co)polymer (C-2-1) according to the present invention is usually within the range of 0.05 to 100 g/10 min, and preferably 0.5 to 100 g/10 min. In the case where the MFR is within the above-described range, the ethylene (co)polymer (C-2-1) exhibits good adhension to rolls and good releasability from the rolls.

<Isotactic Polypropylene (C-2-2)>

The isotactic polypropylene (C-2-2), which may be contained in the ethylene (co)polymer (C-2-1) serving as one of polymer components contained in the syndiotactic propylene based polymer composition according to the present invention, is a propylene homopolymer or a propylene based random copolymer obtained from propylene and an α-olefin having the carbon atom number of 2 to 20 excluding propylene and is a (co)polymer composed of the repeating unit derived from propylene and, as necessary, the repeating unit derived from α-olefin having the carbon atom number of 2 to 20, where the repeating unit derived from propylene is contained at a proportion of 90 to 100 percent by mole, preferably 90 to 99 percent by mole, and further preferably 92 to 98 percent by mole.

Here, as for a-olefins having the carbon atom number of 2 to 20, examples of a-olefins include ethylene, 1-butene, 1-pentene, 1-hexene, 1-octene, 4-methyl-1-pentene, 3-methyl-1-pentene, 1-decene, 1-dodecene, 1-tetradecene, 1-hexadecene, 1-octadecene, and 1-eicosene. Among them, ethylene is preferable.

It is desirable that the MFR (JIS K6721, 230° C., 2.16 kg load) of the isotactic polypropylene according to the present invention is within the range of 0.01 to 200 g/10 min, and preferably 0.01 to 100 g/10 min. In the case where the MFR is within the above-described range, good flowability and good compatibility with other components are exhibited, and the resulting syndiotactic propylene based polymer composition exhibits excellent take-off property from the rolls in forming of a sheet.

<Syndiotactic Propylene Based Polymer Composition>

The syndiotactic propylene based polymer composition according to the present invention is a composition containing 35 to 95 parts by weight, preferably 35 to 90 parts by weight, and further preferably 35 to 85 parts by weight of the above-described syndiotactic propylene·α-olefin copolymer (A), 5 to 25 parts by weight, preferably 5 to 20 parts by weight, and further preferably 5 to 15 parts by weight of the above-described syndiotactic propylene polymer (B), and 0 to 60 parts by weight, preferably 0 to 55 parts by weight, and further preferably 0 to 50 parts by weight of polymer or resin composition (C) composed of at least one type of the above-described ethylene vinyl acetate copolymer (C-1) and polyolefin composition (C-2) [where (A)+(B)+(C)=100 parts by weight].

The composition having a content of syndiotactic propylene·α-olefin copolymer (A) of less than 35 parts by weight exhibits poor transparency, flexibility, scratch resistance, and abrasion resistance. On the other hand, the composition having the content exceeding 95 parts by weight adheres to rolls strongly and take-off property from the rolls is worse in sheet forming.

The sheet formability of the syndiotactic propylene based polymer composition according to the present invention is improved by containing 1 to 60 parts by weight of polymer (C). The preferable range of the polymer (C) is 10 to 60 parts by weight, and further preferable range is 30 to 60 parts by weight. If the amount of polymer (C) exceeds 60 parts by weight, the composition exhibits poor transparency, flexibility, heat resistance, scratch resistance, and abrasion resistance.

In the case where the syndiotactic propylene based polymer composition according to the present invention contains the above-described ethylene (co)polymer (C-2-1) as the polyolefin composition (C-2), the ethylene (co)polymer (C-2-1) may be used alone. However, take-off property from the rolls and the sagging in carrying are improved by adding the above-described isotactic polypropylene (C-2-2). In the case where the above-described isotactic polypropylene (C-2-2) is added, it is preferable that the amount of the isotactic polypropylene is 70 percent by weight or less, and furthermore 60 percent by weight or less relative to the total amount (100 percent by weight) of the ethylene (co)polymer (C-2-1) and the isotactic polypropylene (C-2-2).

It is preferable that the MFR (JIS K6721, 230° C., 2.16 kg load) of the syndiotactic propylene based polymer composition according to the present invention is within the range of usually 0.01 to 200 g/10 min, preferably 0.05 to 150 g/10 min, and further preferably 0.05 to 100 g/10 min. In the case where the MFR is within the above-described range, excellent melting behaviour (easiness in melting of resin) in calendaring and excellent take-off property from the rolls are exhibited, no sagging occurs in carrying, and a sheet by excellent calendering formability is obtained.

<Slipping Agents>

Examples of slipping agents added to the syndiotactic propylene based polymer composition according to the present invention can include various known slipping agents, e.g., stearic acid phosphate systems, stearic amide, oleamide, erucic amide, ethylene-bis-stearamide, silicone oil, and silica.

The syndiotactic propylene based polymer composition according to the present invention can be produced by adopting a method, in which the above-described individual components within the above-described range are mixed through the use of various known methods, e.g., a Henschel mixer, a V-blender, a ribbon blender, and a tumbler blender or a method, in which after mixing, melt-kneading is performed with a single-screw extruder, a twin-screw extruder, a kneader, and a Bambury mixer, followed by pelletization or milling.

The syndiotactic propylene based polymer composition according to the present invention may be blended with 0.01 to 5 parts by weight, and preferably 0.05 to 3 parts by weight of slipping agent relative to 100 parts by weight of the syndiotactic propylene based polymer composition. In the case where the slipping agent is contained within the above-described range, take-off property from the rolls and the scratch resistance in sheet forming are improved.

<Other Additives>

The syndiotactic propylene based polymer composition according to the present invention can be further blended with additives, e.g., an inorganic filler, a nucleation agent, an antioxidant, a flame retardant, an antistatic agent, a pigment, a dye, and an antirust, as necessary.

Typical examples of the above-described inorganic fillers include calcium carbonate, talc, glass fibers, magnesium carbonate, mica, kaolin, calcium sulfate, barium sulfate, titanium white, white carbon, carbon black, aluminum hydroxide, aluminum oxide, magnesium hydroxide, silica, clay, and zeolite. They can be used alone, or at least two types can be used in combination.

Typical examples of the above-described nucleation agents include sodium benzoate, bis-benzylidene sorbitol, bis(p-methylbenzylidene) sorbitol, bis(p-ethylbenzylidene) sorbitol, sodium-2,2-methylenebis(4,6-di-t-butylphenyl)phosphate, talc, titanium oxide, and bis(p-t-butylbenzoyloxy)-hydroxy-aluminum. They can be used alone, or at least two types can be used in combination.

Typical examples of the above-described antioxidants include phenol based antioxidants, e.g., pentaerithrityl-tetrakis[3-(3,5-di-t-butyl-4-hydroxyphenyl) propionate] and triethylene glycol-bis[3-(3-t-butyl-5-methyl-4-hydroxyphenyl)propionate], phosphorus based antioxidants, e.g., tris(monononylphenyl)phosphate and tris(2,4-di-t-butylphenyl)phosphate, and sulfur based antioxidants, e.g., dilauryl thiodipropionate. They can be used alone, or at least two types can be used in combination.

Typical examples of the flame retardants include magnesium hydroxide, calcium hydroxide, and phosphorus based compounds. They can be used alone, or at least two types can be used in combination.

In the case where the above-described additives are added to the syndiotactic propylene based polymer composition according to the present invention, a method in which after the above-described additives are mixed, a composition is prepared by performing kneading with a common kneader, e.g., a roll, a Bambury mixer, a single-screw extruder, or a twin-screw extruder may be adopted, and usually, it is preferable to form into the shape of pellets.

<Formed Body>

The syndiotactic propylene based polymer composition according to the present invention can be widely applied to previously known polyolefin uses and can be used after being formed into formed bodies having various shapes including a sheet, an non-oriented or oriented film, a filament, and the like.

Specific examples of formed bodies include formed bodies obtained by known heat-forming methods, e.g., calendering, extrusion, injection molding, inflation molding, blow molding, extrusion blow molding, injection blow molding, press molding, vacuum forming, and foam molding.

The formed bodies will be described below with reference to several examples. In the case where the formed body according to the present invention is formed by calendering, the shape thereof and the product type are not specifically limited. Examples thereof include a sheet, a film (non-oriented), a pipe, a hose, an electric wire covering, and a filament. In particular, the sheet, the film, the filament, and the like are preferable.

In extrusion of the syndiotactic propylene based polymer composition of the present invention, previously known extruders and molding conditions can be adopted. For example, a molten syndiotactic propylene based polymer composition according to the present invention can be formed into a sheet, a film (non-oriented), or the like through extrusion from a T-die or the like by using a single-screw extruder, a kneading extruder, a ram extruder, a gear extruder, or the like.

<Sheet Forming>

The syndiotactic propylene based polymer composition according to the present invention is particularly suitable for sheet [in general, a product having a large thickness is referred to as a sheet and a product having a small thickness is referred to as a film, although the sheet and the film are generically called “sheet” in the present invention] forming. The sheet forming by using the syndiotactic propylene based polymer composition according to the present invention can be performed through the steps of (step 1): heat-melting the syndiotactic propylene based polymer composition and (step 2): sheet forming the heat-melted syndiotactic propylene based polymer composition.

Furthermore, the step of kneading the heat-melted syndiotactic propylene based polymer composition may be included between the above-described (step 1) and (step 2).

<Calendering>

The syndiotactic propylene based polymer composition according to the present invention is particularly suitable for calendering. The calendering by using the syndiotactic propylene based polymer composition according to the present invention can be performed through the steps of (step 1): heat-melting the syndiotactic propylene based polymer composition and (step 2-1): performing sheet molding through calendering.

Furthermore, the step of kneading the heat-melted syndiotactic propylene based polymer composition may be included between the above-described (step 1) and (step 2-1). Moreover, the above-described (step 2) may include (step 2-2): performing sheet forming and bonding at the same time through calendaring, so as to obtain a laminated sheet.

<Forming of Artificial Leather>

As for forming of an artificial leather, for example, a method for obtaining a laminate by (step 2-1) performing sheet molding through calendering or (step 2-2) performing sheet molding and bonding at the same time through calendering is preferable. However, the sheet obtained by the above-described (step 1) and (step 2) may be taken up and be bonded to a base member separately.

In addition, the step of embossing a pattern on a sheet surface through heat fusion or needle punching may be added at an appropriate stage in a production process of a sheet or a laminate according to the present invention.

That is, the sheet according to the present invention may be subjected to embossing directly. Regarding the laminate, the sheet subjected to embossing and a base member may be bonded together so as to produce a laminate, or embossing may be performed after the laminate is produced.

<Laminate>

The sheet obtained from the syndiotactic propylene based polymer composition according to the present invention can be used by being laminated with various known base members in accordance with uses.

Examples of base members usable for lamination include fabric cloths, knit cloths, nonwoven fabrics, and grain layers, which are formed from at least one of synthetic fibers, natural fibers, inorganic fibers, and mixtures thereof.

Examples of synthetic fibers include synthetic fibers formed from polypropylene, polyethylene, polyester, nylon, acryl, polyurethane, polyvinyl chloride, and silicone.

Examples of natural fibers include cotton, hemp, silk, and wool.

Examples of inorganic fibers include glass fibers and carbon fibers.

Furthermore, examples of fabric cloths can include fabric cloths formed from fibrous raw materials and knit fabrics. Moreover, examples of nonwoven fabrics include webs produced through entanglement of fibrous raw materials by a chemical method, a mechanical method, or a combination thereof.

<Artificial Leather>

The syndiotactic propylene based polymer composition according to the present invention can be used as artificial leathers. The artificial leathers can be used in the fields of automobiles (including two-wheeled vehicles), sports, home appliances, stationery, miscellaneous goods, furniture, clothing, gardening, and construction materials.

Specific examples include floor covers of automobile, ceiling materials, steering wheel, instrument panels, door trims, interior sheets, seat leathers, seat backs, bicycle saddles, deck boards, floor mats, nonslip mats, leisure sheets, gaskets, waterproof sheets, chair skins, bags, satchels, track and field athletic shoes and marathon shoes, running shoes, basket shoes, tennis shoes, golf shoes, walking shoes, jumpers, coats, safety wear, gloves, skiwear, heavy winter mountaineering wear, bands, sashes, ribbons, cellular phone straps, switch plates, jackets, name tags, golf bags, watch belts, bag grips, golf club grips, boots, notebook covers, book covers, key holders, ashtray cases, cigarette cases, carrying cases, pen cases, pen grips, purses, card cases, pass holders, surfaces and backs of tatami mats, wall paper, shoulder straps, sandals, slippers, boats, waterbeds, tent materials, albums, address book covers, nursing goods (bed covers), baseballs, basketballs, handballs, dodgeballs, tablecloths, accordion curtains, luminaires, stuffed toys, desk pads, desk covers, frames, harness and saddlery, belts, hats, parachutes, kayaks, sofas, cushion covers, ball skins, mouse pads, emblems, badges, bracelets, necklaces, storage boxes, greenhouse sheets, chests of drawers, tables, and tissue boxes, although not limited to the above description.

In particular, application to uses for automobile interior members, e.g., floor covers of automobile, ceiling materials, steering wheel, instrument panels, door trims, interior sheets, and seat leathers, is favorable from the viewpoint of excellence in the abrasion resistance and the scratch resistance, the water resistance, weight reduction, and good recycle performance.

Furthermore, in particular, application to sports goods, e.g., mats, surfaces and backs of tatami mats, running shoes, mountaineering boots, balls, kayaks, and skiwear is favorable because of the water resistance, weight reduction, no smell, and no color migration.

### EXAMPLES

The present invention will be further specifically described below with reference to examples. However, the present invention is not limited to these examples.

In this regard, the property values and the like in the examples and the comparative examples were measured as described below.

(1) Limiting Viscosity [η] (dl/g)

The value was measured by using decalin at 135° C. That is, about 20 mg of polymerized powder, pellet, or resin lump was dissolved into 15 ml of decalin, and the specific viscosity ηₛₚ was measured in an oil bath at 135° C. After this decalin solution was diluted by adding 5 ml of decalin solvent, the specific viscosity ηₛₚ was measured in the same manner. This dilution operation was repeated further two times, and the value of ηₛₚ/C when the concentration (C) was extrapolated to zero was determined as the limiting viscosity (refer to the following formula).

[η]=lim(ηₛₚ/C) (C→0)

(2) Molecular Weight Distribution (Mw/Mn)

The molecular weight distribution (Mw/Mn) was measured as described below by using a gel permeation chromatograph Model Alliance GPC-2000 produced by Waters Corporation. Separation columns were two TSKgel GNH6-HT and two TSKgel GNH6-HTL. The size of each column was 7.5 mm in diameter and 300 mm in length. The column temperature was specified to be 140° C. As for the mobile phase, o-dichlorobenzene (Wako Pure Chemical Industries, Ltd.) and 0.025 percent by weight of BHT (Takeda Pharmaceutical Company limited) serving as an antioxidant were used, and were moved at 1.0 ml/min. The sample concentration was specified to be 15 mg/10 ml, the amount of injection of sample was specified to be 500 microliters, and a differential refractometer was used as a detector. Standard polystyrenes produced by Tosoh Corporation were used where the molecular weight satisfied Mw<1,000 and Mw>4×10⁶, and those produced by Pressure Chemical Company were used where 1,000≦Mw≦4×10⁶.

(3) Ethylene, Propylene, and α-olefin Contents in Polymer

Regarding quantification of the ethylene, propylene, and α-olefin contents, the measurement was performed as described below by using Model JNM GX-400 NMR measuring apparatus produced by JEOL LTD. Heat-dissolution of 0.35 g of sample into 2.0 ml of hexachlorobutadiene was performed. The resulting solution was filtrated with a glass filter (G2).

Thereafter, 0.5 ml of deuterated benzene was added, putting into an NMR tube having an inside diameter of 10 mm was performed, and the ¹³C·NMR measurement was performed at 120° C.

The number of integration was specified to be 8,000 times or more. The composition of the ethylene, propylene, and α-olefin was quantified on the basis of the resulting ¹³C·NMR spectrum.

(4) Stereoregularity (rrrr Pentad and rr Triad)

Quantification was performed on the basis of the ¹³C·NMR measurement under the same condition as that described above.

The pentad fraction (rrrr fraction) is determined by the following formula (1) from the absorption intensity Prrrr (absorption intensity attributed to a methyl group in the third unit at the site where five propylene units constitute continuous syndiotactic bond) and the absorption intensity Pw (absorption intensity attributed to all methyl groups in the propylene units) in a ¹³C·NMR spectrum.

rrrr fraction (%)=100×Prrrr/Pw (1)

The triad fraction (rr fraction) is determined by the following formula (2) from the absorption intensity Prr (absorption intensity attributed to a methyl group in the second unit at the site where three propylene units constitute continuous syndiotactic bond) and the absorption intensity Pw (absorption intensity attributed to all methyl groups in the propylene units) in a ¹³C·NMR spectrum.

rr fraction (%)=100×Prr/Pw (2)

(5) Glass Transition Temperature (Tg), melting point (Tm), and amount of heat of melting (J/g) of syndiotactic propylene·α-olefin copolymer (A)

The value were determined from the endothermic curve, where DSC produced by Seiko Instruments Inc., was used, about 5 mg of sample was packed into an aluminum pan for the measurement, the temperature was raised to 230° C. at 100° C./min and was kept at 230° C. for 5 minutes, thereafter the temperature was lowered to −150° C. at 10° C./rain, and subsequently the temperature was raised to 230° C. at 10° C./min.

(6) Melting Point (Tm) of Syndiotactic Propylene Polymer (B)

The melting point was measured from a peak top of a crystal melting peak, where DSC Pyris 1 or DSC 7 produced by PerkinElmer, Inc., was used, and in a nitrogen atmosphere (20 ml/min),the temperature of about 5 mg of sample was raised to 230° C. and was kept for 10 minutes, followed by cooling to 30° C. at 10° C./rain, and after the temperature was kept at 30° C. for 5 minutes, the temperature was raised to 230° C. at 10° C./rain.

(7) MFR (g/10 min)

The MFRs of the syndiotactic propylene·α-olefin copolymer (A) and the syndiotactic propylene polymer (B) were measured on the basis of JIS K6721 at 230° C. and 2.16 kgf load.

The MFRs of the ethylene-vinyl acetate copolymer (C-1) and the ethylene (co)polymer (C-2-1) were measured on the basis of JIS K7210.1999 at 190° C. and 2.16 kgf load.

(8) Method for Producing Press Sheet for Measuring Oil resistance

A hydraulic hot-pressing machine produced by Shindo Kinzoku Kogyo K.K., set at 200° C. was used, a syndiotactic propylene based polymer composition was used, and a press sheet having a thickness of 1 mm was molded. At this time, preheating was performed for about 5 to 7 minutes, a pressure was applied at 10 MPa for 1 to 2 minutes and, thereafter, compression was performed at 10 MPa by using another hydraulic hot-pressing machine produced by Shindo Kinzoku Kogyo K.K., set at 20° C., followed by cooling for about 5 minutes, so that a sample for measurement was formed. As for a heating plate, a brass plate having a thickness of 5 mm was used. The sample produced by the above-described method was used as a sample for an oil resistance test.

(9) Oil Resistance

The above-described press sheet 3 cm square having a thickness of 1 mm was immersed in JIS No. 3 oil, followed by keeping at 70° C. for 72 hours, and the rate of change in volume ΔV (%) and the rate of change in mass ΔW (%) between before and after the immersion were measured.

Furthermore, the above-described press sheet 3 cm square having a thickness of 1 mm was immersed in liquid paraffin oil (light) (produced by NACALAI TESQUE, INC., NACALAI standard Analytical GR Commodity cord 26132-35 CAS No.; 8012-95-1), followed by keeping at 80° C. for 24 hours, and the rate of change in volume ΔV (%) and the rate of change in mass ΔW (%) between before and after the immersion were measured.

(10) Rate of Change in Gloss (%) After Gakushin (Japan Society for the Promotion of Science) Abrasion (Frictional Wearing Test)

A Japan Society for the Promotion of Science-type abrasion tester produced by Toyo Seiki Seisaku-sho, Ltd., was used, a test piece having a thickness of 300 μm was used, the end of a 45R SUS abrasion indenter 470 g was covered with a cotton sail cloth #10, and the sample was abraded with this at 23° C., the number of reciprocating movements of 100 times, a reciprocating movement speed of 33 times/min, and a stroke of 100 mm. The rate of change in gloss Δgloss (incident angle: 60 degrees) before and after the abrasion was determined as described below.

Δgloss=(gloss before abrasion−gloss after abrasion)/gloss before abrasion×100

(11) Taber Abrasion Weight Loss

A test piece having a thickness of 300 μm was evaluated.

A CS#10 abrasive wheel with a load of 500 g was used, the sample was abraded with this at 23° C., the number of revolutions of 500 times, and a rotation speed of 70 times/min, and weight loss of abrasion was measured on the basis of the change in mass before and after the abrasion.

(12) Density (kg/m³)

The density was measured on the basis of ASTM D1505.

(13) Evaluation of Calendering Formability

Calendering was performed by using a syndiotactic propylene based polymer composition. A reverse L type calendering machine having rolls was used. The diameter of each roll was 6 inches. The roll temperature was specified to be 165° C., and a sheet having a thickness of 300 μm was formed.

The individual items of the melting behaviour, take-off property from the rolls, and the sagging in carrying were evaluated. The evaluation was performed visually, and the sample having no problem in practical use was indicated by AA and the sample having a problem in practical use was indicated by BB.

<Polymerization of Syndiotactic Propylene·α-olefin copolymer (A)>

[Syndiotactic Propylene·Ethylene Copolymer (a-1)]

A 1.5-liter autoclave subjected to drying under reduced pressure and nitrogen substitution was charged with 750 ml of heptane at ambient temperature. Subsequently, 0.3 ml of 1.0-mmol/ml toluene solution of TIBA (triisobutylaluminum) was added in such a way that the amount becomes 0.3 mmol in terms of aluminum atom, and 50.7 liter (25° C., 1 atmosphere) of propylene was introduced under agitation. The temperature raising was started and finally controlled keeping 30° C. Thereafter, the inside of the system was pressurized with ethylene up to 5.5 kg/cm²G, 3.75 ml of heptane solution (0.0002 mmol/ml) of diphenylmethylene(cyclopentadienyl)(fluorenyl)zirconium dichloride synthesized by a known method and 2.0 ml of toluene solution (0.002 mmol/ml) of triphenylcarbenium tetra(pentafluorophenyl)borate were added, so as to start copolymerization between propylene and ethylene. Regarding the catalyst concentration at this time, diphenylmethylene(cyclopentadienyl)fluorenyl zirconium dichloride was 0.001 mmol/L, and triphenylcarbenium tetra(pentafluorophenyl)borate was 0.004 mmol/L relative to the total system.

During the polymerization, ethylene was fed continuously and, thereby, the internal pressure was kept at 5.5 kg/cm²G. The polymerization reaction was terminated 30 minutes after the starting of the polymerization by adding methyl alcohol.

After depressurization, a polymer solution was taken out. The resulting polymer solution was washed by using “aqueous solution in which 5 ml of concentrated hydrochloric acid was added to 1 liter of water” at a proportion of 1:1 relative to the resulting polymer solution, so as to shift a catalyst residue to a water phase. After the resulting catalyst mixed solution was stood, the water phase was separated and removed, and furthermore, washing with distilled water was performed two times, and the polymerization liquid phase was oil-water separated. Then, the oil-water separated polymerization liquid phase was brought into contact with a triple amount of acetone under vigorous agitation to precipitate a copolymer. Subsequently, washing with acetone was performed sufficiently and a solid part (copolymer) was taken through filtration. Drying was performed at 130° C. and 350 mmHg for 12 hours while nitrogen was passed.

The yield of the thus obtained syndiotactic propylene ethylene copolymer (a-1) was 50 g, the limiting viscosity [η] measured in decalin at 135° C. was 2.4 dl/g, and the MFR (JIS K6721, 230° C., 2.16 kg load) was 2.0 g/10 min. The glass transition temperature (Tg) was −28° C., and a melting peak of a crystal having an amount of heat of melting of 1 J/g or more was not observed within the range of −150° C. to 200° C.

Regarding the composition, the repeating unit derived from propylene was 76.0 percent by mole, the repeating unit derived from ethylene was 24.0 percent by mole, and the molecular weight distribution (Mw/Mn) measured on the basis of GPC was 2.9.

[Syndiotactic Propylene-butene·ethylene Copolymer (a-2)]

After a 2,000-ml polymerization apparatus subjected to nitrogen substitution sufficiently was charged with 833 ml of dry hexane, 120 g of 1-butene, and triisobutylaluminum (1.0 mmol) at ambient temperature, the temperature in the polymerization apparatus was raised to 60° C., the pressure in the system was pressurized with propylene up to 0.33 MPa and, then, the pressure in the system was adjusted at 0.63 MPa with ethylene. Subsequently, a toluene solution in which 0.002 mmol of di(p-chlorophenyl)methylene(cyclopentadienyl)(octamethyloctahydrod ibenzofluorenyl)zirconium dichloride was brought into contact with 0.6 mmol, in terms of aluminum, of methylaluminoxane (produced by Tosoh Finechem Corporation) was added into a reactor. Polymerization was effected for 20 minutes at an internal temperature of 60° C. while the pressure in the system was kept at 0.63 MPa with ethylene, and polymerization was terminated by adding 20 ml of methanol. After depressurization, a polymer was precipitated from the polymerization solution in 2 L of methanol, and was dried in a vacuum at 130° C. for 12 hours. The resulting syndiotactic propylene-butene-ethylene copolymer (a-2) was 97 g, and [η]=2.3 (dl/g) where the measurement was performed in decalin at 135° C. The MFR (JIS K6721, 230° C., 2.16 kg load) was 1.3 g/10 min. The glass transition temperature obtained on the basis of DSC was −23.8° C., and a melting peak of a crystal having an amount of heat of melting of 1 J/g or more was not observed within the range of −150° C. to 200° C.

Regarding the composition, the repeating unit derived from propylene was 62 percent by mole, the repeating unit derived from ethylene was 10 percent by mole, and the repeating unit derived from butene was 28 percent by mole.

<Polymerization of Syndiotactic Propylene Polymer (B)>

[Syndiotactic Propylene Homopolymer (b-1)]

A glass autoclave with an internal volume of 500 ml subjected to nitrogen substitution sufficiently was charged with 250 ml of toluene, and propylene was passed through at an amount of 150 L/hour, followed by keeping at 25° C. for 20 minutes. On the other hand, a magnetic stirrer was put into a side-arm flask with an internal volume of 30 ml subjected to nitrogen substitution sufficiently, and 5.00 mmol of toluene solution of methylaluminoxane (Al=1.53 mol/l ) and, then, 5.0 μmol of toluene solution of dibenzylmethylene(cyclopentadienyl)(3,6-di-tert-butylfluorenyl)zirconium dichloride were added, followed by agitation for 20 minutes. The resulting solution was added to toluene in the glass autoclave, through which propylene was passed, and polymerization was started. A propylene gas was fed continuously at an amount of 150 L/hour and polymerization was effected at normal pressure and 25° C. for 45 minutes. Thereafter, the polymerization was terminated by adding a small amount of methanol. The polymer solution was added to large excess methanol to precipitate a polymer, and drying under reduced pressure was performed at 80° C. for 12 hours. As a result, 2.38 g of polymer was obtained. The polymerization activity was 0.63 kg-PP/mmol-Zr·hr, regarding the resulting syndiotactic propylene homopolymer (b-1), [η] was 1.9 dl/g, Tm=158° C. (Tm1=152° C., Tm2=158° C.), the pentad fraction (rrrr fraction) was 93.5%, and the Mw/Mn=2.0. The MFR (JIS K6721, 230° C., 2.16 kg load) was 6.0 g/10 min.

<Ethylene·vinyl Acetate Copolymer (C-1)>

[Ethylene·vinyl Acetate Copolymer (c-11)

Trade name Evaflex EV270 produced by DUPONT-MITSUI POLYCHEMICALS CO LTD., [vinyl acetate 28 percent by weight, MFR (JIS K7210.1999) 1.0 g/10 min].

[Ethylene·vinyl Acetate Copolymer (c-12)

Trade name Evaflex EV360 produced by DUPONT-MITSUI POLYCHEMICALS CO LTD., [vinyl acetate 25 percent by weight, MFR (JIS K7210.1999) 2.0 g/10 min].

[Ethylene vinyl Acetate Copolymer (c-13)

Trade name Evaflex EV560 produced by DUPONT-MITSUI POLYCHEMICALS CO LTD., [vinyl acetate 14 percent by weight, MFR (JIS K7210.1999) 3.5 g/10 min].

<Ethylene (co)polymer (C-2-1)>

[Ethylene·α-olefin copolymer (c-22)

Trade name TAFMER A4085 produced by Mitsui Chemicals, Inc., [MFR (JIS K7210.1999) 3.6 g/10 min, density 885 kg/m³].

[Ethylene·α-olefin Copolymer (c-23)

Trade name TAFMER A4050S produced by Mitsui Chemicals, Inc., [MFR (JIS K7210.1999) 3.6 g/10 min, density 864 kg/m³].

<Isotactic Polypropylene (C-2-2)>

[Isotactic Propylene·Ethylene Random Copolymer (c-24)

Trade name Prime Polypro F219DA produced by Prime Polymer Co., Ltd., [MFR (JIS K7210 230° C., 2.16 kg load) 8.0 g/10 min, density 910 kg/m³].

### Examples 1 to 12

The above-described syndiotactic propylene·α-olefin copolymer (A), syndiotactic propylene polymer (B), ethylene·vinyl acetate copolymer (C-1), ethylene (co)polymer (C-2-1), and isotactic polypropylene (C-2-2) were blended at a ratio described in Table 1, sheet forming was performed through calendering. The sheet properties and the formability are shown in Table 1-1 and Table 1-2.

TABLE 1-1

| | | | Example 1 | Example 2 | Example 3 | Example 4 | Example 5 | Example 6 | Example 7 | Example 8 |
|---|---|---|---|---|---|---|---|---|---|---|
| Polymer | (a-1) | wt % | 85 | | | | | | | |
| | (a-2) | wt % | | 85 | 60 | 60 | 60 | 42 | 60 | 42 |
| | (b-1) | wt % | 15 | 15 | 10 | 10 | 10 | 8 | 10 | 8 |
| | (c-11) | wt % | | | | | | | 30 | 50 |
| | (c-12) | wt % | | | 30 | 30 | 30 | 50 | | |
| | (c-22) | wt % | | | | | | | | |
| | (c-23) | wt % | | | | | | | | |
| | (c-24) | wt % | | | | | | | | |
| Slipping agent | stearic acid | phr | | | | 1 | | | | |
| | phosphate | | | | | | | | | |
| | Ethylene-bis- | phr | | | | | 0.4 | | | |
| | stearamide | | | | | | | | | |
| Sheet thickness | | μm | 300 | 300 | 300 | 300 | 300 | 300 | 300 | 300 |
| DSC-Tm | Tm | ° C. | 158 | 158 | 158 | 158 | 158 | 158 | 158 | 158 |
| Density | | kg/m³ | 880 | 880 | 910 | 910 | 910 | 940 | 910 | 910 |
| MFR | | g/10 min | 2.6 | 2.0 | 2.5 | 2.5 | 2.5 | 2.8 | 1.9 | 1.9 |
| Gakushin abrasion | Before test | | 88 | 88 | 70 | 55 | 63 | 70 | 57 | 59 |
| | After test | | 47 | 55 | 16 | 26 | 24 | 11 | 9 | 9 |
| | Δ Gloss | | 41 | 33 | 54 | 29 | 39 | 59 | 49 | 51 |
| | Rate of change in | % | 47 | 37 | 78 | 54 | 62 | 83 | 85 | 86 |
| | gloss | | | | | | | | | |
| Taber abrasion | Amount of | mg | 0.0 | 0.0 | 0.0 | 1.5 | 1.8 | 1.1 | 4.0 | 0.6 |
| | abrasion loss | | | | | | | | | |
| Calendering | Melting behaviour | | AA | AA | AA | AA | AA | AA | AA | AA |
| formability | take-off property | | AA | AA | AA | AA | AA | AA | AA | AA |
| | from the rolls | | | | | | | | | |
| | Sagging in | | AA | AA | AA | AA | AA | AA | AA | AA |
| | carrying | | | | | | | | | |
| Oil resistance test | ΔW | % | | 130 | 432 | | | | | |
| JIS No. 3 Oil | ΔV | % | | 120 | 455 | | | | | |
| Oil resistance test | ΔW | % | | 119 | 295 | | | | | |
| Liquid paraffin oil | ΔV | % | | 128 | 319 | | | | | |

TABLE 1-2

| | | | Example 9 | Example 10 | Example 11 | Example 12 |
|---|---|---|---|---|---|---|
| Polymer | (a-1) | wt % | | | | |
| | (a-2) | wt % | 42 | 42 | 42 | 60 |
| | (b-1) | wt % | 8 | 8 | 8 | 10 |
| | (c-11) | wt % | | | | |
| | (c-12) | wt % | | | | |
| | (c-22) | wt % | | 35 | 20 | 10 |
| | (c-23) | wt % | 35 | | | |
| | (c-24) | wt % | 15 | 15 | 30 | 20 |
| Slipping agent | stearic acid | phr | | | | |
| | phosphate | | | | | |
| | Ethylene-bis- | phr | | | | |
| | stearamide | | | | | |
| Sheet thickness | | μm | 300 | 300 | 300 | 300 |
| DSC-Tm | Tm | ° C. | 158 | 158 | 158 | 158 |
| Density | | kg/m³ | 880 | 880 | 880 | 880 |
| MFR | | g/10 min | 4.7 | 4.7 | 4.9 | 3.5 |
| Gakushin | Before test | | 7 | 20 | 36 | 14 |
| abrasion | After test | | 6 | 15 | 35 | 14 |
| | Δ Gloss | | 1 | 5 | 1 | 0 |
| | Rate of change in | % | 19 | 24 | 3 | 0 |
| | gloss | | | | | |
| Taber abrasion | Amount of abrasion | mg | 0.0 | 0.0 | 0.0 | 0.0 |
| | loss | | | | | |
| Calendering | Melting behaviour | | AA | AA | AA | AA |
| formability | take-off property | | AA | AA | AA | AA |
| | from the rolls | | | | | |
| | Sagging in carrying | | AA | AA | AA | AA |
| Oil resistance | ΔW | % | | 188 | 157 | |
| test JIS No. 3 Oil | ΔV | % | | 175 | 151 | |
| Oil resistance | ΔW | % | | 141 | 136 | |
| test Liquid | ΔV | % | | 147 | 142 | |
| paraffin oil | | | | | | |

### Comparative Examples 1 to 6

<Polymerization of Isotactic Propylene·α-olefin Copolymer (A′)>

[Isotactic Propylene·Butene·Ethylene Copolymer (a′-1)]

After a 4,000-ml polymerization apparatus subjected to nitrogen substitution sufficiently was charged with 1,834 ml of dry hexane, 120 g of 1-butene, and triisobutylaluminum (1.0 mmol) at ambient temperature, the temperature in the polymerization apparatus was raised to 60° C., and the pressure in the system was pressurized with propylene to 0.56 MPa. Then, the pressure in the system was adjusted at 0.7 MPa with ethylene. Subsequently, a toluene solution in which 0.001 mmol of diphenylmethylene(3-tert-butyl-5-methyl-cyclopentadienyl) (2,7-di-tert-butyl-fluorenyl)zirconium dichloride was brought into contact with 0.3 mmol, in terms of aluminum, of methylaluminoxane (produced by Tosoh Finechem Corporation) was added into a reactor. Polymerization was effected for 20 minutes at an internal temperature of 60° C. while the pressure in the system was kept at 0.75 MPa with ethylene, and polymerization was terminated by adding 20 ml of methanol. After depressurization, a copolymer was precipitated from the polymerization solution in 4 L of methanol, and was dried in a vacuum at 130° C. for 12 hours. The resulting isotactic propylene·butene·ethylene copolymer (a′-1) was 102.5 g, and the MFR (JIS K6721, 230° C., 2.16 kg load) was 7.1 g/10 min. Regarding the composition, the repeating unit derived from propylene was 62 percent by mole, the repeating unit derived from ethylene was 10 percent by mole, and the repeating unit derived from 1-butene was 28 percent by mole.

<Polymerization of Syndiotactic Propylene Polymer (BT)>

[Syndiotactic Propylene Homopolymer (b′-1)]

A syndiotactic propylene homopolymer (b′-1) was obtained following the method described in Japanese Unexamined Patent Application Publication No. H02-274763 through the use of the catalyst composed of diphenylmethylene(cyclopentadienyl)fluorenyl zirconium dichloride and methylaluminoxane by a bulk polymerization method in the presence of hydrogen. Regarding the resulting syndiotactic propylene homopolymer (b′-1), the MFR (JIS K6721, 230° C., 2.16 kg load) was 4.4 g/10 min, the molecular weight distribution on the basis of GPC was 2.3, the syndiotactic propylene homopolymer (b′-1) triad fraction (rr fraction) measured on the basis of ¹³C·NMR was 82%, the Tm measured on the basis of the differential scanning calorimeter was 127° C., and Tc was 57° C.

The syndiotactic propylene·α-olefin copolymer (A), the isotactic propylene·α-olefin copolymer (A′), the syndiotactic propylene polymer (B′), the ethylene·vinyl acetate copolymer (C-1), the ethylene (co)polymer (C-2-1), and the isotactic polypropylene (C-2-2) were blended at a ratio described in Table 2, sheet forming was performed through calendering. The sheet properties and the formability are shown in Table 2.

The properties of the sheets and the calendering formability of polyvinyl chloride and polyurethane are shown in Table 2.

TABLE 2

| | | | Comparative | Comparative | Comparative | Comparative | Comparative | Comparative |
|---|---|---|---|---|---|---|---|---|
| | | | example 1 | example 2 | example 3 | example 4 | example 5 | example 6 |
| Polymer | | | | | | | PVC | PU |
| | (a-1) | wt % | | 30 | | | | |
| | (a-2) | wt % | | | | | | |
| | (a′-1) | wt % | | | | 70 | | |
| | (b′-1) | wt % | 90 | 42 | | | | |
| | (c-12) | wt % | 10 | | | | | |
| | (c-13) | wt % | | | 10 | | | |
| | (c-22) | wt % | | | | | | |
| | (c-23) | wt % | | | | | | |
| | (c-24) | wt % | | 28 | 90 | 30 | | |
| Sheet thickness | | μm | 300 | 300 | 300 | 300 | 80 | 50 |
| DSC-Tm | Tm | ° C. | 127 | 127 | 118 | 118 | — | — |
| Density | | kg/m³ | 890 | 960 | 910 | 910 | 1300 | 1200 |
| MFR | | g/10 min | 4.3 | 4.7 | 7.8 | 7.4 | | |
| Gakushin | Before test | | 88 | 20 | — | — | 7 | 12 |
| abrasion | After test | | 55 | 14 | — | — | 7 | 12 |
| | A Gloss | | 33 | 6 | — | — | 1 | 0 |
| | Rate of change in | % | 37 | 30 | — | — | 10 | 2 |
| | gloss | | | | | | | |
| Taber abrasion | Amount of | mg | 0.0 | 0.0 | 2.0 | 2.0 | 0.0 | 0.8 |
| | abrasion loss | | | | | | | |
| Calendering | Melting behaviour | | BB | BB | AA | AA | AA | AA |
| formability | take-off property | | BB | BB | AA | BB | AA | AA |
| | from the rolls | | | | | | | |
| | Sagging in | | BB | BB | BB | BB | AA | AA |
| | carrying | | | | | | | |

### INDUSTRIAL APPLICABILITY

The syndiotactic propylene based polymer composition according to the present invention can be applied as a syndiotactic propylene based polymer composition, a formed body, and a laminated sheet/film, which have excellent calendering formability, which exhibit excellent abrasion resistance, scratch resistance, and the like and, in addition, which are suitable for a sheet for an artificial leather exhibiting improved smell, color migration, and the like, to various uses described in the above-described item of the artificial leather.

1. A syndiotactic propylene based polymer composition comprising, (A) 35 to 95 parts by weight of syndiotactic propylene·α-olefin copolymer containing 50 percent by mole or more, and less than 90 percent by mole of repeating unit derived from propylene, (B) 5 to 25 parts by weight of syndiotactic propylene polymer characterized by satisfying the following requirement (b), the requirement being such that (b) the syndiotactic pentad fraction (rrrr fraction) measured on the basis of ¹³C·NMR is 85% or more, the melting point (Tm) determined on the basis of DSC is 145° C. or higher, and the repeating unit derived from propylene at an amount of more than 90 percent by mole (where the total amount of repeating unit in the syndiotactic propylene polymer (B) is assumed to be 100 percent by mole) and (C) 0 to 60 parts by weight of polymer or resin composition containing at least one type of the following (C-1) and (C-2), (C-1) an ethylene·vinyl acetate copolymer, (C-2) a polyolefin based resin composition composed of the following (C-2-1) and (C-2-2) [where (C-2-1)+(C-2-2)=100 percent by weight], (C-2-1)30 to 100 percent by weight of ethylene (co)polymer, (C-2-2) 0 to 70 percent by weight of isotactic polypropylene, [where (A)+(B)+(C)=100 parts by weight].

2. A syndiotactic propylene based polymer composition produced by adding 0.1 to 5 parts by weight of slipping agents relative to 100 parts by weight of syndiotactic propylene based polymer composition according to claim 1.

3. A formed body comprising the syndiotactic propylene based polymer composition according to claim 1.

4. A sheet comprising the syndiotactic propylene based polymer composition according to claim 1.

5. A film comprising the syndiotactic propylene based polymer composition according to claim 1.

6. A laminate comprising the sheet according to claim 4.

7. An artificial leather comprising the sheet according to claim 4.

8. A method for manufacturing a sheet comprising the steps of (step 1): heat-melting the syndiotactic propylene based polymer composition according to claim 1; and (step 2): sheet forming the heat-melted syndiotactic propylene based polymer composition.

9. The method for manufacturing a sheet, according to claim 8, comprising the step of kneading the heat-melted syndiotactic propylene based polymer composition between the (step 1) and the (step 2).

10. The method for manufacturing a sheet, according to claim 8, wherein the (step 2) is a (step 2-1): performing sheet forming through calendering.

11. A method for manufacturing a laminate characterized in that in the method for manufacturing a sheet, according to claim 8, the (step 2) is a (step 2-2): performing sheet forming and bonding at the same time through calendering.

12. A method for manufacturing an artificial leather characterized in that in the method for manufacturing a sheet, according to claim 8, the (step 2) is a (step 2-2): performing sheet forming and bonding at the same time through calendering.

13. A laminate comprising the film according to claim 5.

14. An artificial leather comprising the film according to claim 5.
